(19) United States
(12) Patent Application Publication
(10) Pub. No.: US 2005/0000328 A1
(43) Pub. Date: Jan. 6, 2005

(54) Twisted handle for hand tools

(76) Inventor: Chih-Ching Hsien, Taichung (TW)

Correspondence Address: Mr. Phillip LIU, 6980, Whiteoak Dr., Richmond, BC, V7E 4Z9, CA

(21) Appl. No.: 10/612,214

(22) Filed: Jul. 3, 2003

(51) Int. Cl. B25B 13/16

(52) U.S. Cl. 81/170

(57) ABSTRACT

A hand tool includes a handle and at least one operation end is connected to an end of the handle. The handle includes a first section and a second section, a twist portion is connected between the first section and the second section. The second section has a wide surface which is located on a plane which is perpendicular to a plane where a surface of the at least one operation end is located. The user applies a force at the wide surface to rotate the at least one operation end so that the user's hand is suffered less pressure.

### FIELD OF THE INVENTION

The present invention relates to a handle for a hand tool such as a wrench and the handle twists at a mediate portion thereof so as to facilitate applying force and operation of the tool.

### BACKGROUND OF THE INVENTION

A conventional hand tool such as a wrench generally includes a handle and two ends, such as an open end and a box end. The open end and the box end is able to mounted to an object such as a nut or a bolt head and the user holds the handle to rotate the hand tool so as to apply a torque to the object. Generally, the surface of the two ends of the wrench are located parallel to the surface of the handle so that the user has to hold the handle perpendicular to the axis of the object so as to apply a maximum torque to the object. The handle is made in a flat configuration which includes two pairs of opposite surfaces. The surface of the handle that is parallel to the surface of the two ends is much wider than the adjacent surface of the handle. When operating the handle, the user's hand applies the force to the narrow surface so as to rotate the handle, and the narrow surface generates a large pressure to the user's hand. If the user operates the handle for a period of time, the pressure applied to the palm of the hand could not be tolerated.

The present invention intends to provide a handle that twists at the mediate portion so that the user applies the force to a wide surface to loosen or tighten the objects.

### SUMMARY OF THE INVENTION

In accordance with one aspect of the present invention, there is provided a hand tool which comprises a handle and at least one operation end is connected to an end of the handle. The handle includes a twist portion which is connected between a first section and a second section. The at least one operation end is connected to the first section and the second section has a wide surface which is located on a plane which is perpendicular to a plane where a surface of the at least one operation end is located.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hand tool of the present invention;

FIG. 2 is a top view of the hand tool of the present invention;

FIG. 3 is a side view of the hand tool of the present invention;

FIG. 4 shows that a user's hand holds the handle and rotates the hand tool;

FIG. 5 discloses another embodiment of the present invention, and

FIG. 6 shows that a user holds the handle of the hand tool shown in FIG. 5.

### DETAILED DESCRIPTION OF THE PREFERRED EMBODIMENT

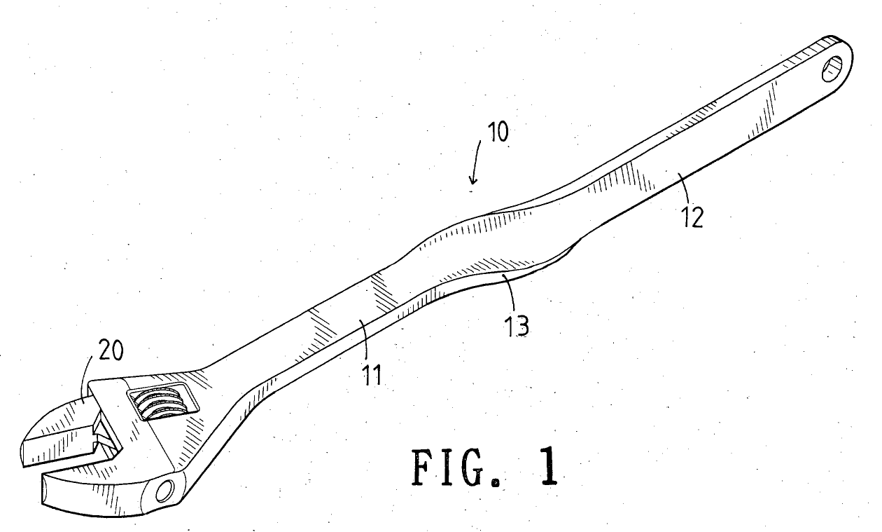

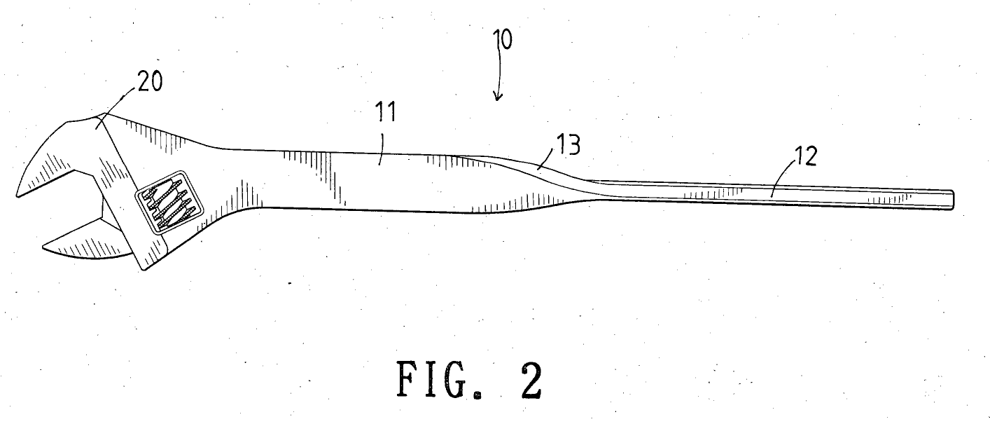

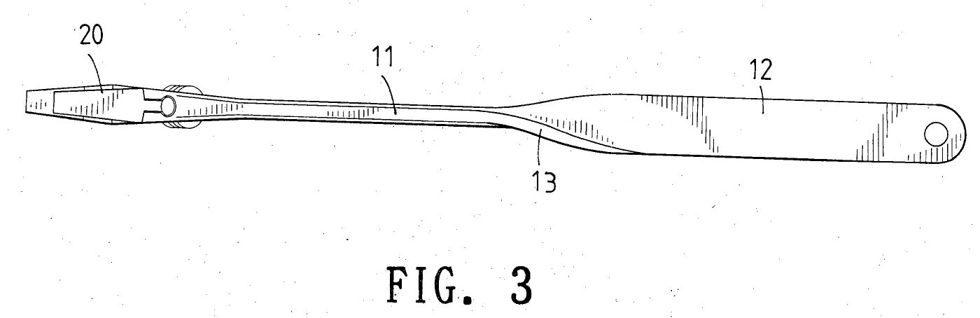

Referring to FIGS. 1 to 3, the hand tool such as a spanner of the present invention comprises a handle 10 and at least one operation end 20 which is an open end is connected to an end of the handle 10. The handle 10 includes a first section 11 and a second section 12, the at least one operation end 20 connected to the first section 11. A twist portion 13 is located at a mediate portion of the handle 10 and the first section 11 and the second section 12 are respectively connected to two ends of the twist portion 13. Each of the first section 11 and the second section 12 is an elongate flat piece which has a rectangular cross section and includes two wide surface and two narrow surfaces.

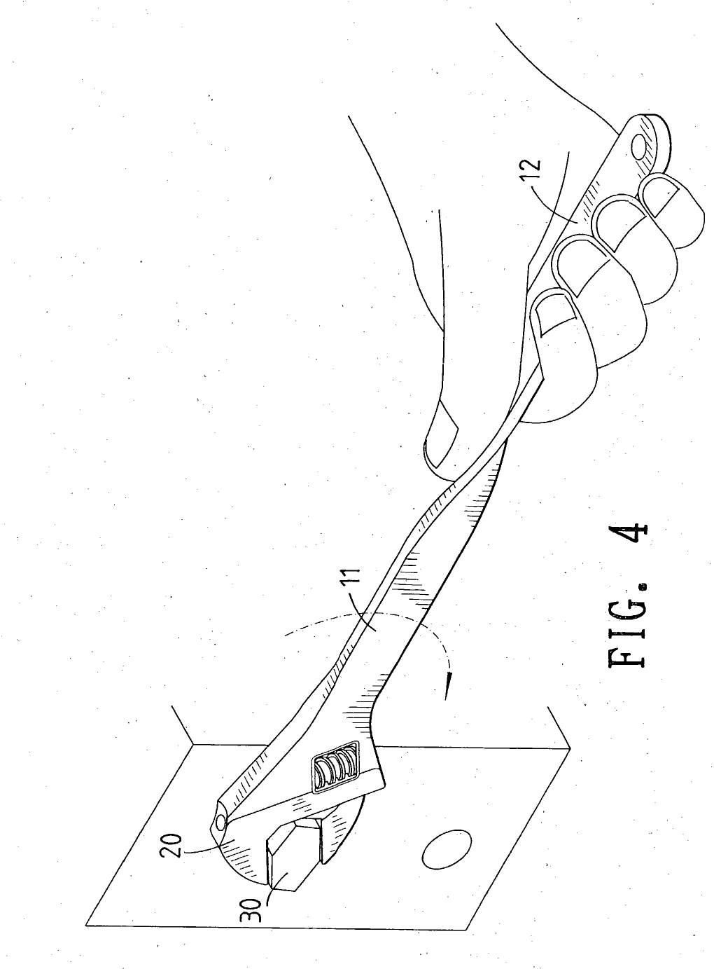

One of the two wide surfaces of the second section 12 is located on a plane which is perpendicular to a plane where a surface of the at least one operation end 20 is located. As shown in FIG. 4, when the user holds the second section 12 and rotates the handle 10, the force is applied perpendicular to an axis the object 30 which is clamped by the at least one operation end 20. In other words, the force is applied to the wide surface of the second section 12 and generates less pressure to the hand of the user. The wide surface of the second section 12 is perpendicular to the at least one operation end 20, so that the force is fully used to generate a torque to loosen or tighten the object 30.

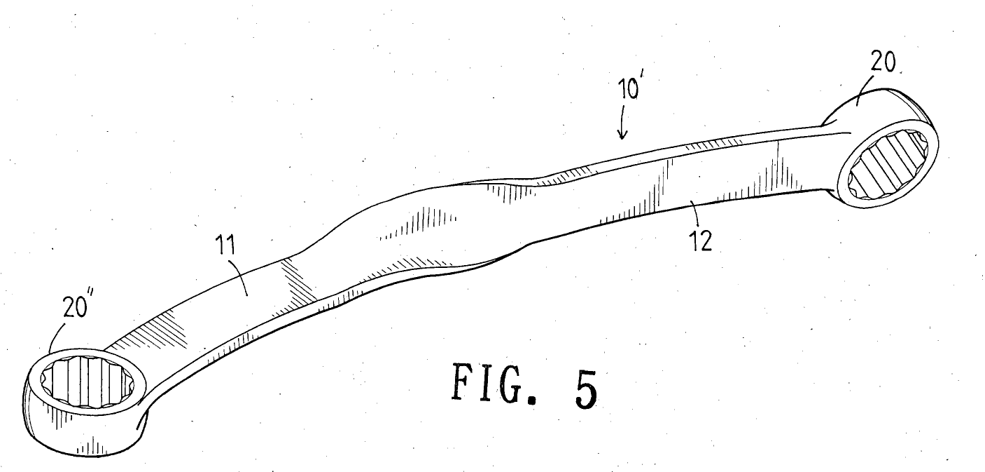

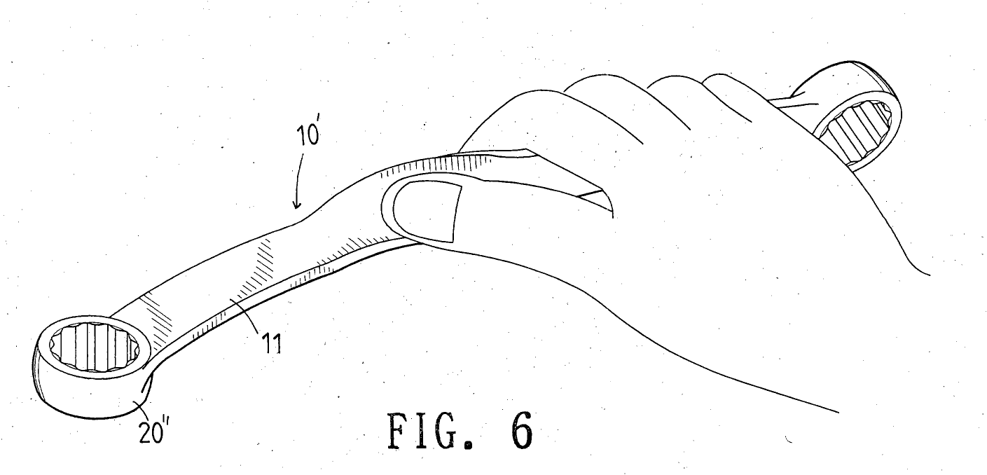

Referring to FIGS. 5 and 6, the handle 10′ can be a curve and flat plate and each of two ends of the handle 10′ is connected with an operation end 20′, 20″. When using the operation end 20′, the user holds the first section 11 of the handle 10′, and holds the second section 12 when using the operation end 20″.

While we have shown and described the embodiment in accordance with the present invention, it should be clear to those skilled in the art that further embodiments may be made without departing from the scope of the present invention.

1. A hand tool comprising:
a handle and at least one operation end connected to an end of the handle, the handle including a first section and a second section, the at least one operation end connected to the first section, the second section having a wide surface which is located on a plane which is perpendicular to a plane where a surface of the at least one operation end is located.

2. The hand tool as claimed in claim 1, wherein the handle has a twist portion which is located at a mediate portion thereof and the first section and the second section are respectively connected to two ends of the twist portion.

3. The hand tool as claimed in claim 1, wherein the handle is a curve and flat plate.
